(19) United States
(12) Patent Application Publication
(10) Pub. No.: US 2007/0213422 A1
(43) Pub. Date: Sep. 13, 2007

(54) Polymer Foams of Very Low Density and Their Process of Manufacture

(75) Inventors: Remy Collier, Dijon (FR); Patrick Vedrenne, Dijon (FR); Edmond Lebrun, Bretigny (FR)

Correspondence Address: MCKENNA LONG & ALDRIDGE LLP, 1900 K STREET, NW, WASHINGTON, DC, 20006, US

(73) Assignee: Commissariat A L'energie tomique

(21) Appl. No.: 10/580,264

(22) PCT Filed: Nov. 25, 2004
(86) PCT No.: PCT/FR04/50616

§ 371 Date: Mar. 27, 2007

(30) Foreign Application Priority Data
Nov. 28, 2003 (FR) 0350932

(51) Int. Cl. B29C 44/34

(52) U.S. Cl. 521/142

(57) ABSTRACT

The invention relates to novel foams obtained by highly concentrated internal phase emulsion polymerization, which are formed from a crosslinked, exclusively hydrocarbon, polymer based on styrenic monomers and which exhibit a density at least equal to 6 mg/cm³ and at most equal to 20 mg/cm³ and cells with a mean diameter at most equal to 20 microns. It also relates to the process for the manufacture of these foams.

### TECHNICAL FIELD

The present invention relates to polymer foams of very low density and to their process of manufacture.

The foams according to the invention are “polyHIPE” foams, that is to say foams obtained by polymerization of a highly concentrated internal phase emulsion, which are characterized not only by a particularly low density but also by a very low mean cell diameter and by a very high degree of purity.

They are thus of particular use in carrying out experiments in the field of plasma physics and in particular as targets for the study of inertial confinement fusion phenomena but also as materials intended to absorb energy (thermal, sound or mechanical insulation, and the like) or liquids, materials for the filtration and separation of substances, supports for impregnation with and/or for controlled release of substances (catalyst supports, vehicle for medicinal active principles, and the like) or as fillers for structures for which it is desired to lighten the weight.

### STATE OF THE PRIOR ART

“PolyHIPE” (Polymerized High Internal Phase Emulsion) foams are polymer foams which are obtained by polymerization of an emulsion composed, on the one hand, of a dispersing organic phase which comprises polymerizable monomers and a surface-active agent in solution in a solvent and, on the other hand, of a dispersed aqueous phase which represents at least 74% of the total volume of emulsion and which includes an initiator for polymerization of said monomers.

After removing the water present in the product resulting from this polymerization, open-cell foams are obtained, which cells correspond to the imprint of the water bubbles being formed in the emulsion during its preparation and which are interconnected via openings which are smaller in size than them, commonly denoted under the term of “pores”.

These foams exhibit a high void volume/solid volume ratio and thus a low density, as well as an isotropic, spherical and uniform cell structure, making them very different from the conventional polymer foams obtained by blowing or extrusion, which are characterized by an anisotropic, oriented and nonuniform cell structure.

Due to their characteristics, “polyHIPE” foams are the subject of increasing interest and their use has been proposed in numerous fields, including in particular the manufacture of disposable absorbent articles (U.S. Pat. No. 5,331,015 [1]), of insulating articles (U.S. Pat No. 5,770,634 [2]) and of filtration membranes and devices (WO-A-97/37745 [3]).

In order to further widen their potential for applications, the Inventors set themselves the goal of providing “polyHIPE” foams having the lowest possible density and, for this density, the lowest possible mean cell diameter, while exhibiting a satisfactory mechanical strength which allows them to be formed by mechanical machining (for example turning) or by laser.

Moreover, they set themselves the goal of providing “polyHIPE” foams which have, in addition to the abovementioned properties, a very high degree of purity and which can be prepared by a process that is simple to implement and which is compatible economically with manufacture on the industrial scale.

### ACCOUNT OF THE INVENTION

These goals, and others besides, are achieved by the present invention, which provides a “polyHIPE” foam which is formed from a crosslinked, exclusively hydrocarbon, polymer based on styrenic monomers and which exhibits a density at least equal to 6 mg/cm³ and at most equal to 20 mg/cm³ and cells with a mean diameter at most equal to 20 microns.

According to a first advantageous provision of the invention, the polymer is a copolymer of styrene and of divinylbenzene.

This copolymer can in particular be obtained from commercially available styrene and divinylbenzene monomers, in which case the divinylbenzene is composed of a mixture of the three ortho, meta and para isomeric forms, with the meta form predominant.

Advantageously, in this copolymer, the ratio by weight of the styrene to the divinylbenzene is between 4 and 1 and better still equal to 1.

In accordance with the invention, the foam preferably exhibits a mean cell diameter of between 2 and 10 microns.

According to another advantageous provision of the invention, the foam exhibits a level of impurities by weight of less than 3%, that is to say that the elements present in this foam, other than the constituent carbon and the constituent hydrogen of the polymer, represent less than 3% by weight of the weight of said foam.

A foam in accordance with the invention can in particular be obtained by using, in a highly concentrated internal phase emulsion polymerization process:
a pore-forming agent, in the case in point ethylbenzene, which, at the same time, is a solvent for the styrenic monomers without being a solvent for the resulting polymer,
sorbitan monooleate, which exhibits a hydrophilic-lipophilic balance of 4.3, as surface-active agent, and
sodium persulfate as initiator for polymerization of said monomers, this being because the joint use of these three agents has proved to make it possible to prepare a very concentrated emulsion, that is to say an emulsion in which the dispersed aqueous phase represents at least 96% of the total volume of this emulsion.

Consequently, another subject matter of the invention is a process for the manufacture of a polyHIPE foam as defined above which comprises the following stages:

a) producing an emulsion between an organic phase comprising exclusively hydrocarbon styrenic monomers and sorbitan monooleate in ethylbenzene and an aqueous phase comprising an electrolyte and sodium persulfate, the volume of the aqueous phase representing at least 96% of the total volume of the two phases;

b) polymerizing said monomers until a solid foam is obtained; and

c) washing the foam obtained in stage b) and subjecting it to drying with supercritical CO₂.

According to an advantageous provision of this process, the styrenic monomers present in the organic phase are styrene and divinylbenzene monomers in a ratio by weight of between 4 and 1 and better still equal to 1.

These monomers advantageously represent from 40 to 60% by weight of the weight of the organic phase, while the sorbitan monooleate represents from 20 to 30% by weight of the weight of this organic phase.

The electrolyte present in the aqueous phase, the role of which is to stabilize the emulsion by modifying the properties of the sorbitan monooleate, is preferably aluminum sulfate and advantageously represents from 0.1 to 2% by weight of the weight of this aqueous phase. However, this electrolyte can also be chosen from various other salts, for example of aluminum, of copper or of sodium.

For its part, the sodium persulfate preferably represents from 0.1 to 2% by weight of the weight of the aqueous phase.

Furthermore, it is preferable to use, in the aqueous phase, ultrapure water, in particular water with a resistivity of close to or equal to 18.2 megaohms (MΩ), for example obtained by nanofiltration, ultrafiltration, ion exchange or distillation, this being because the level of purity of water used has an effect on the purity of the foam obtained.

In accordance with the invention, the emulsion between the organic phase and the aqueous phase is produced, for example in a reactor equipped with a stirrer shaft, by gradually adding, with moderate stirring, the aqueous phase to the organic phase already present in the reactor and by then subjecting the combined mixture to more vigorous stirring, for example corresponding to a rotational speed of the shaft of 300 revolutions/min, until a stable emulsion is obtained. A stable emulsion is generally obtained by maintaining the stirring for 60 to 90 minutes.

The polymerization of the monomers is preferably carried out under hot conditions, that is to say at a temperature of the order of 30 to 70° C., for example in an oven. It can optionally be carried out after having placed the emulsion in a hermetically sealed container in order to avoid possible contamination of this emulsion during this stage. The time necessary for the polymerization of the monomers to result in a solid foam is generally of the order of 12 to 48 hours.

According to another advantageous provision of the invention, the washing of the foam comprises one or more washing operations with water, preferably ultrapure water, followed by several washing operations with water/alcohol mixtures with an increasing content of alcohol, themselves followed by one or more washing operations with the alcohol. The alcohol used during these washing operations is preferably ethanol.

In accordance with the invention, the foam, once washed, is subjected to drying with supercritical CO₂, this being because this drying technique makes it possible to completely extract the solvent from the foam without destroying the solid structure of this foam.

Other characteristics and advantages of the invention will become more clearly apparent on reading the remainder of the description which follows, which is given, of course, by way of illustration and without implied limitation and with reference to the appended drawings.

### BRIEF DESCRIPTION OF THE DRAWINGS

FIG. 1 represents three photographs taken using a scanning electron microscope on a sample of a foam in accordance with the invention, part A corresponding to a magnification of ×30.4, part B to a magnification of ×126 and part C to a magnification of ×1940.

FIG. 2 represents, in the form of a histogram, the frequency (F) of the cells of a sample of a foam in accordance with the invention as a function of their diameter (D), expressed in microns.

FIG. 3 represents, in the form of a histogram, the frequency (F) of the pores of a sample of a foam in accordance with the invention as a function of their diameter (D), expressed in microns.

### DETAILED ACCOUNT OF A SPECIFIC EMBODIMENT

A batch of samples of a polymer foam in accordance with the invention is prepared by following the procedure below.

In a first step, an organic phase comprising 2.25 g of styrene, 2.25 g of divinylbenzene and 2.33 g of sorbitan monooleate in 4.28 g of ethylbenzene is prepared, all these compounds originating from Aldrich.

This organic phase is introduced into the vessel of a glass chemical reactor with a jacket in which a heat-exchange fluid circulates, in the case in point water maintained at 20° C. by a thermostatically controlled bath. The reactor is closed by a leaktight lid pierced by 4 ground-glass necks, a central ground-glass neck of which allows a stirrer shaft to pass through and two side ground-glass necks of which serve to connect the reactor respectively to the end of a pressure-equalizing dropping funnel and to a vacuum pump.

At the same time, an aqueous phase is prepared comprising 0.102 g of aluminum sulfate (Aldrich) and 2.5 g of sodium persulfate (Aldrich) in 290 ml of ultrapure water with a resistivity equal to 18.2 MΩ.

This aqueous phase is introduced into the vessel of the reactor via the pressure-equalizing dropping funnel and the rotational speed of the stirrer shaft is brought to 300 revolutions/min over 30 seconds. This stirring is maintained for 70 minutes and then the reactor is placed under partial vacuum (109 mbar) using the vacuum pump. The stirring is continued for a further 5 minutes and then halted, and the vacuum is broken after standing for 4 minutes.

The emulsion thus formed in the reactor is distributed in a series of glass tubes using a spatula.

These tubes are introduced into plastic bags containing 1 cm³ of ultrapure water. The bags are closed by welding and placed in an oven at 60° C. for 17hours, at the end of which the tubes are removed from the oven and allowed to cool until their temperature is equal to ambient temperature.

The samples of foam which are present in the glass tubes are manually extracted therefrom and then placed in a beaker filled with ultrapure water. The water is changed 3 times over 24 hours.

They are then transferred into a beaker containing 25% of ethanol and 75% of ultrapure water. The ethanol content is subsequently brought to 100% in stages of 25% over a period of 4 days.

After removing from the beaker, the foam samples are dried in a supercritical CO₂ drier.

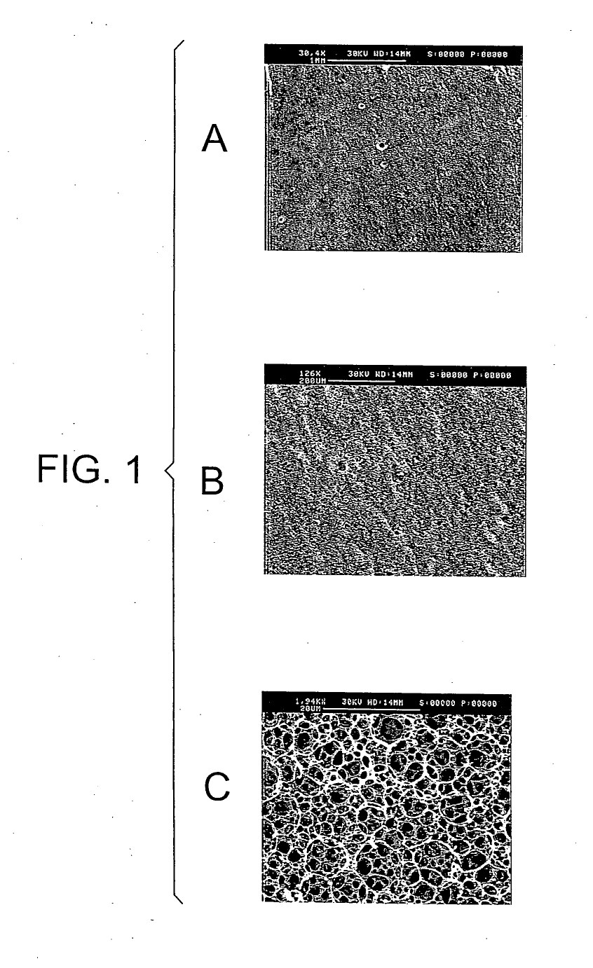

The foam samples thus produced are characterized by:
a mean density of 17.2 mg/cm³±1.7 mg/cm³,
a very homogeneous structure, as is shown in FIG. 1, which represents three photographs taken with a scanning electron microscope, respectively at a magnification of ×30.4 (part A), ×126 (part B) and ×1940 (part C), on a foam sample,
a mean cell diameter of 6.30 μm±1.81 μm,
a mean pore diameter of 1.35 μm±0.88 μm, and
a level of impurities (elements other than carbon and hydrogen) by weight of less than 3% (% by weight: C=92.3±0.5%; H=7.90±0.3%; O=1.10±0.3%; ppm: S=50 ppm; Na=3 ppm; Al=336 ppm).

The density was determined by subjecting two samples, taken at random, oh the one hand to a measurement of size using digital calipers (uncertainty of measurement: ±10 pm) and, on the other hand, to weighing (uncertainty of measurement: ±10 μg).

The mean cell diameters and the mean pore diameters were determined over respectively 82 cells and 837 pores using image analysis software from images obtained by scanning electron microscopy.

For its part, the level of impurities by weight was determined by elemental analysis.

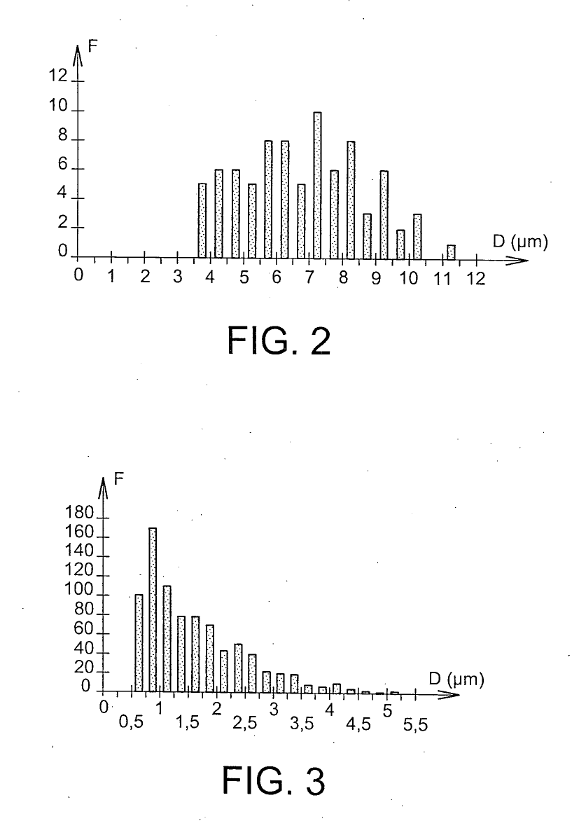

FIG. 2 illustrates, in the form of a histogram, the frequency (F) of these cells as a function of their diameter (D), expressed in μm, while FIG. 3 illustrates, also in the form of a histogram, the frequency (F) of these pores as a function of their diameter (D), also expressed in μm.

### BIBLIOGRAPHY

[1] U.S. Pat. No. 5 331 015
[2] U.S. Pat. No. 5 770 634
[3] WO-A-97/37745

1. A polymer foam obtained by highly concentrated internal phase emulsion polymerization, which is formed from a crosslinked, exclusively hydrocarbon, polymer based on styrenic monomers and which exhibits a density at least equal to 6 mg/cm³ and at most equal to 20 mg/cm³ and cells with a mean diameter at most equal to 20 microns.

2. The polymer foam as claimed in claim 1, in which the polymer is a copolymer of styrene and of divinylbenzene.

3. The polymer foam as claimed in claim 2, in which the ratio by weight of the styrene to the divinylbenzene in the copolymer is between 4 and 1 and is preferably equal to 1.

4. The polymer foam as claimed in claim 1, which exhibits a mean cell diameter of between 2 and 10 microns.

5. The polymer foam as claimed in claim 1, in which the elements other than the constituent carbon and the constituent hydrogen of the polymer represent less than 3% by weight of the weight of the foam.

6. A process for the manufacture of a polymer foam as claimed in claim 1, which comprises the following stages:
a) producing an emulsion between an organic phase comprising exclusively hydrocarbon styrenic monomers and sorbitan monooleate in ethylbenzene and an aqueous phase comprising an electrolyte and sodium persulfate, the volume of the aqueous phase representing at least 96% of the total volume of the two phases;
b) polymerizing said monomers until a solid foam is obtained;
c) washing the foam obtained in stage b) and subjecting it to drying with supercritical CO₂.

7. The process as claimed in claim 6, in which the styrenic monomers present in the organic phase are styrene and divinylbenzene monomers.

8. The process as claimed in claim 7, in which the ratio by weight of the styrene monomers to the divinylbenzene monomers is between 4 and 1 and is preferably equal to 1.

9. The process as claimed in claim 6, in which the styrenic monomers represent from 40 to 60% by weight of the weight of the organic phase.

10. The process as claimed in claim 6, in which the sorbitan monooleate represents from 20 to 30% by weight of the weight of the organic phase.

11. The process as claimed in claim 6, in which the electrolyte is aluminum sulfate.

12. The process as claimed in claim 6, in which the electrolyte represents from 0.1 to 2% by weight of the weight of the aqueous phase.

13. The process as claimed in claim 6, in which the sodium persulfate represents from 0.1 to 2% by weight of the weight of the aqueous phase.

14. The process as claimed in claim 6, in which the water present in the aqueous phase is ultrapure water.

15. The process as claimed in claim 14, in which the ultrapure water present in the aqueous phase has a resistivity of approximately 16.2 megaohms.

16. The process as claimed in claim 6, in which the polymerization of the monomers is carried out at a temperature ranging from 30 to 70° C.

17. The process as claimed in claim 6, in which the washing of the foam comprises one or more washing operations with water, followed by several washing operations with water/alcohol mixtures with an increasing content of alcohol, themselves followed by one or more washing operations with the alcohol.
